(19) United States
(12) Patent Application Publication
(10) Pub. No.: US 2010/0166249 A1
(43) Pub. Date: Jul. 1, 2010

(54) Dual loop speaker

(75) Inventor: Steff Lin, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: HI-TECH SOUND SYSTEM CO., LTD., TAIPEI (TW)

(21) Appl. No.: 12/318,508

(22) Filed: Dec. 30, 2008

(51) Int. Cl. H04R 1/00

(52) U.S. Cl. 381/413

(57) ABSTRACT

A dual loop speaker having a low profile is disclosed to include a bracket holding a magnet and a U-yoke around the magnet, a damper connected between the bracket and the U-yoke, a cone paper connected between the bracket and the damper and having an inside step, a dust cover bonded to the inside step of the cone paper, a sound coil mounted inside the dust cover and sleeved onto the magnet with the periphery thereof connected to the dust cover, and a tweeter mounted inside the sound coil. When electric current is connected to the sound coil to excite the magnet, the sound coil is cause to vibrate the cone paper and the damper, and the vibration of the cone paper causes sound. Because the sound coil is provided above the cone paper, the height of the speaker is minimized.

### BACKGROUND OF THE INVENTION

1. Field of the Invention

The present invention relates to speakers and more particularly, to a dual loop speaker, which has a low profile, facilitating installation and providing a high practical value.

2. Description of the Related Art

FIG. 1 shows a conventional dual loop speaker, which comprises a bracket 14, a T-iron 11, a magnet 12 supported on the T-iron 11, a washer 13 attached to the magnet 12 and fastened with the magnet 12 and the T-iron 11 to the bottom side of the bracket 14, a cone paper 15 and a damper 16 suspending inside the bracket 14, a sound coil 17 mounted on the magnet 12, and a tweeter 18 mounted in the sound coil 17. When an electric current is connected to the sound coil 17 to excite the magnet 12, the cone paper 15 is caused to vibrate, thereby producing sound. According to this design of dual loop speaker, the sound coil 17 is connected with the cone paper 15 and the damper 16 inside the bracket 14 and the magnet 12 supported on the T-iron 11 and mounted with the washer 13 on the outside of the bracket 14, the whole structure of the dual loop speaker has a certain height. When installing the dual loop speaker in a car, wall or any other support means, the limitation of height affects the installation work.

Therefore, it is desirable to provide a dual loop speaker that eliminates the aforesaid problem.

### SUMMARY OF THE INVENTION

The present invention has been accomplished under the circumstances in view. It is one object of the present invention to provide a dual loop speaker, which has a low profile, facilitating installation and providing a high practical value.

To achieve this and other objects of the present invention, the dual loop speaker comprises a bracket holding a magnet and a U-yoke around the magnet, a damper connected between the bracket and the U-yoke, a cone paper connected between the bracket and the damper and having a locating portion on the inside, a dust cover bonded to the inside step of the cone paper, a sound coil mounted inside the dust cover and sleeved onto the magnet with the periphery thereof connected to the dust cover, and a tweeter mounted inside the sound coil; When electric current is connected to the sound coil to excite the magnet, the sound coil is cause to vibrate the cone paper and the damper, and the vibration of the cone paper causes sound. Because the sound coil is provided above the cone paper, the height of the speaker is minimized.

Further, the locating portion of the cone paper extends radially inwards in horizontal and then axially backwards in vertical, forming a step. Further, the dust cover has a bottom bearing flange bonded to the locating portion of the cone paper.

Further, the damper has its one end bonded with one end of cone paper to the periphery of the U-yoke.

### BRIEF DESCRIPTION OF THE DRAWINGS

FIG. 1 is a sectional view of a dual loop speaker according to the prior art.

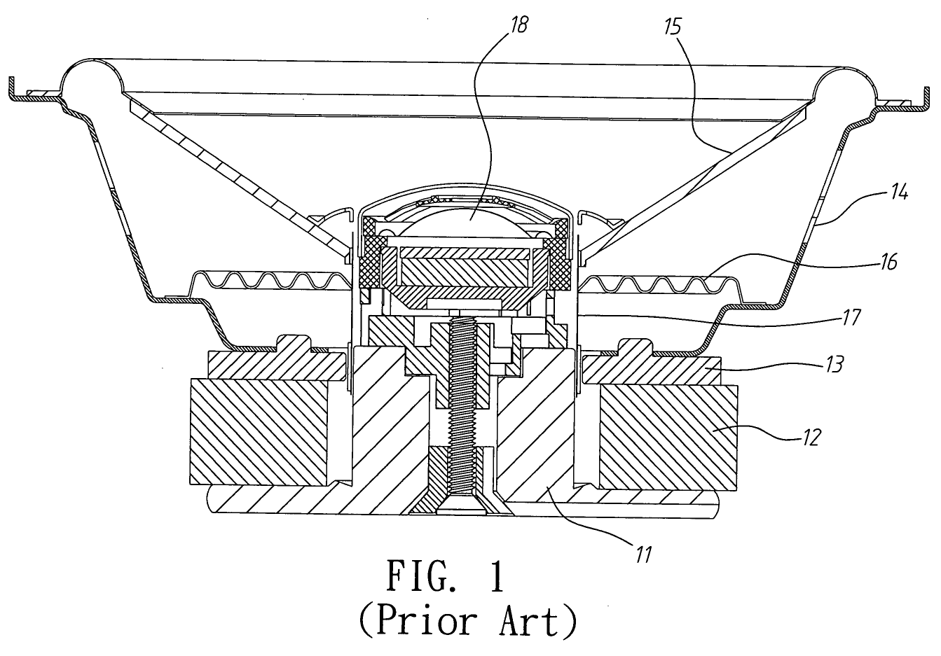

FIG. 2 is a perspective view of a dual loop speaker in accordance with the present invention.

FIG. 3 is an exploded view of the dual loop speaker in accordance with the present invention.

FIG. 4 is a sectional view of the dual loop speaker in accordance with the present invention.

### DETAILED DESCRIPTION OF THE PREFERRED EMBODIMENT

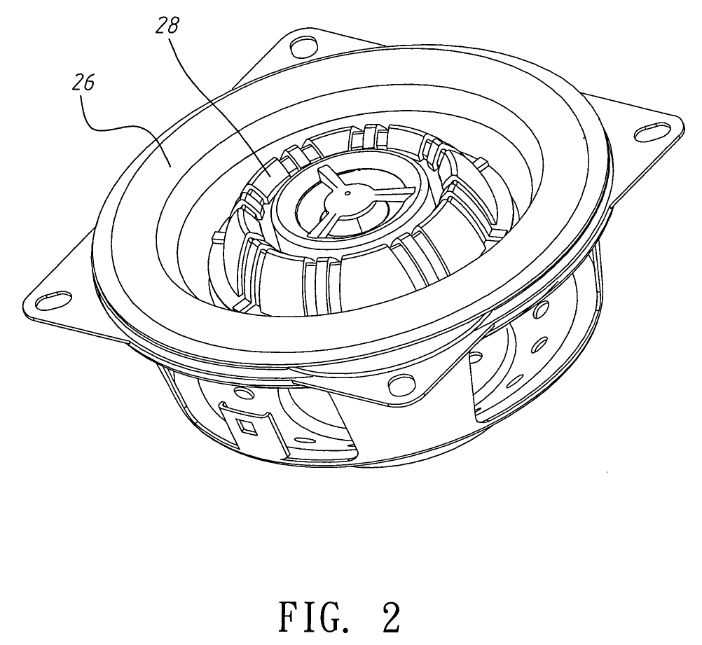

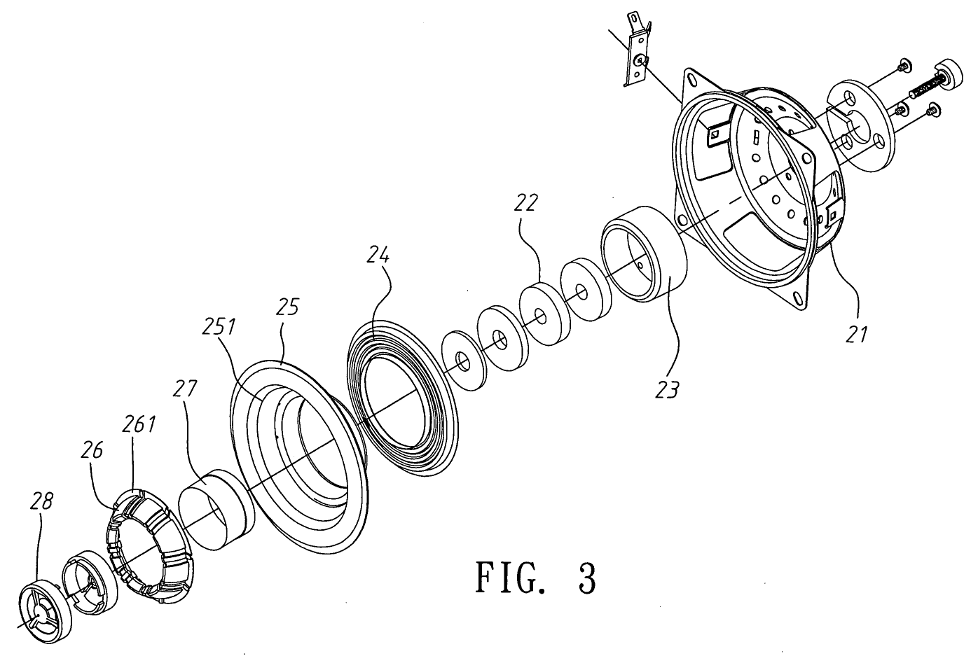

Referring to FIGS. 2 and 3, a dual loop speaker constructed according to the present invention is shown comprising a bracket 21, a magnet 22 and a U-yoke 23 mounted in the bracket 21, a damper 24, a cone paper 25, a dust cover 26, a sound coil 27 and a tweeter 28. The damper 24 has its one end connected to the bracket 21, and its other end affixed to the U-yoke 23. The cone paper 25 has its one end connected to the bracket 21 and its other end connected to the damper 24, having a locating portion 251 that is extends radially inwards in horizontal and then axially backwards in vertical to form a step. The dust cover 26 has a bottom bearing flange 261 bonded to the locating portion 251 of the cone paper 25. The sound coil 27 is mounted inside the dust cover 26 and sleeved onto the magnet 22, having the periphery thereof connected to the dust cover 26. The tweeter 28 is mounted inside the sound coil 27.

When electric current is connected to the sound coil 27 to act upon the magnet 22, the sound coil 27 is caused to vibrate the dust cover 26, the cone paper 25 and the damper 24, and the vibration of the cone paper 25 causes sound.

As stated above, the sound coil 27 is mounted in the cone paper 25 at the top side so that the elevation of the magnet 22 and the U-yoke 23 can be lifted, lowering the profile of the dual loop speaker, facilitating the installation of the dual loop speaker in a car, wall or any other support means and raising the practical value of the dual loop speaker.

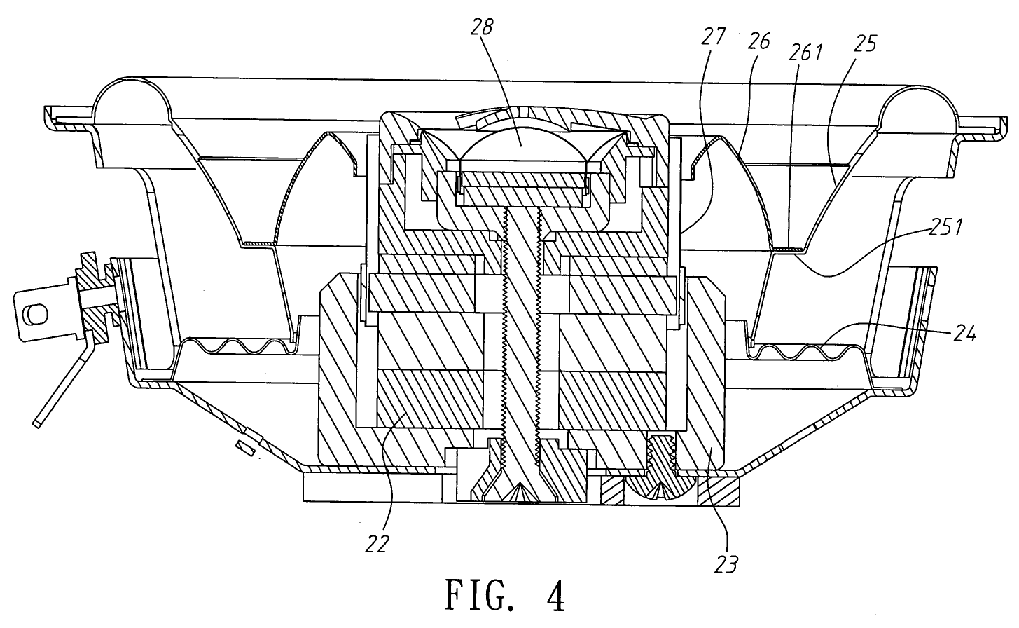

Referring to FIG. 4, the sound coil 27 is mounted in the cone paper 25 at the top side so that the elevation of the magnet 22 and the U-yoke 23 can be lifted, lowering the profile of the dual loop speaker. During operation, the sound coil 27 is electrically connected to act upon the magnet 22, the sound coil 27 is caused to vibrate the dust cover 26, the cone paper 25 and the damper 24, and the vibration of the cone paper 25 causes sound. Therefore, the invention eliminates the drawback of high profile of the prior art design in which the sound coil is provided at the bottom side of the bracket.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A dual loop speaker, comprising a bracket, a magnet, a U-yoke, a sound coil, a damper and a cone paper, wherein said cone paper comprises a locating portion, a dust cover bonded to said locating portion to hold said sound coil inside said cone paper around said magnet for causing vibration of said cone paper to produce sound upon connection of an electric current to said sound coil; by means of the arrangement of said sound coil above said cone paper, the height of the speaker is minimized.

2. The dual loop speaker as claimed in claim 1, wherein said locating portion extends radially inwards in horizontal and then axially backwards in vertical to form a step.

3. The dual loop speaker as claimed in claim 1, wherein said dust cover comprises a bottom bearing flange bonded to the locating portion of said cone paper.

4. The dual loop speaker as claimed in claim 1, wherein said damper comprises one end bonded with one end of said cone paper to the periphery of said U-yoke.
